(19) United States
(12) Patent Application Publication
(10) Pub. No.: US 2019/0211226 A1
(43) Pub. Date: Jul. 11, 2019

(54) Microcrystalline Wax/Pre-Mixture Liquid Sealant Composition, Method of Manufacture and Methods of Use

(71) Applicant: Promxx, LLC, d/b/a Waterbear Pro LLC, Weatherford, TX (US)

(72) Inventor: Russell Leon Haskell, Weatherford, TX (US)

(21) Appl. No.: 16/240,165

(22) Filed: Jan. 4, 2019

Related U.S. Application Data
(60) Provisional application No. 62/613,970, filed on Jan. 5, 2018.

(51) Int. Cl. C09D 191/06; C09D 7/20; C10G 73/42

(52) U.S. Cl. CPC C09D 191/06; B05D 1/02; C10G 73/42; C09D 7/20

(57) ABSTRACT

A method and composition are shown for treating a variety of different substrates with a sealant coating composition which provides a long lasting protective barrier on a selected substrate. First a sealant composition is formulated by combining a micro-crystalline wax with an organic solvent pre-mixture blend. Next, the selected substrate is contacted with the sealant composition and the solvent blend is allowed to flash away, leaving behind a substantially solvent free micro-crystalline wax residue barrier. The solvent blend can be a mixture of hexane and xylene but is not limited to these two particular solvents.

### CROSS REFERENCE TO RELATED APPLICATIONS

The present application claims priority to U.S. Provisional Patent Application Ser. No. 62/613,970 filed Jan. 5, 2018, by the same inventor and with the same title.

### BACKGROUND OF THE INVENTION

### 1. Field of the Invention

The present invention relates generally to a formula for a protective coating. More specifically, the formula is for a liquid sealant barrier comprised of a micro crystalline wax in a chemical pre-mixture.

### 2. Description of the Prior Art

In industries such as marine, transit and rail, architecture, and outdoor (wood, stone, etc) surface coatings and sealants play a vital role in protecting and extending the life, and aesthetic appeal, of assets from corrosive elements. Various environmental factors such as salts, acids, UV-rays, moisture and graffiti affect substrates in day to day life. Prevention of corrosion, is a global concern that is estimated by a 2016 NACE International Study to cost $2.5 trillion annually. Numerous methods and materials are employed to reduce corrosion and minimize maintenance cost. Currently available methods, though vast, are often complicated, expensive and difficult to apply. Asset protection in the form of coatings and sealants is a global demand that spans industries, substrates, materials, and environmental factors—for example but not limited only to these:

| | | | Environmental |
|---|---|---|---|
| Categories | Substrates: | Materials: | Factors: |
| Industrial Applications | Woods | Polymers | Salts |
| Wood Coatings | Metals | Silicones | Acids |
| Architectural Coatings | Concrete | Water-Based | UV - Rays |
| “Green Coatings” | Stone | Oil-Based | Moisture |
| Marine Coatings | Brick | | Graffiti |
| | Stucco | | |

*the above list is not complete and is meant only to illustrate broad categories

Asset protection depends greatly on the substrate being protected, the environment in which that substrate is built and consumed, and the functional nature and requirements of the asset.

All assets when exposed to environmental elements begin a cycle of decay. Corrosion and material degradation caused by salts, acids, ultra-violet rays, moisture and the like are estimated to cause trillions of dollars' worth of damage annually.

Corrosion and material degradation is the destruction of a substance or its properties because of a reaction with its environment.

On a small scale example, an individual might be using fishing and hunting gear “in the field,” where equipment is easily exposed to the elements. In addition to water damage, fishing and hunting gear such as firearms, fishing reels, and exposed electronics on boats can be damaged by salt and other corrosive materials.

It is a further object of the present invention to provide a liquid sealant coating barrier that may easily be applied by any of a number of convenient means, such as by spraying, brushing or rolling. It is another object to provide such a liquid sealant coating barrier which is economical to manufacture using a number of readily available chemical components.

Another object is to provide such a liquid sealant coating barrier which, once, blended, has an extended shelf life.

### SUMMARY OF THE INVENTION

The foregoing objects of the invention are met through a formula for a liquid sealant barrier which combines a micro-crystalline wax with a special chemical pre-mixture, to be described in greater detail hereafter. In one embodiment, the micro-crystalline wax is combined with a special organic solvent pre-mixture blend. The solvent pre-mixture blend keeps the micro-crystalline wax in an emulsified state until it is applied. Upon application, the solvent blend flashes away. The result is a liquid sealant barrier which can be applied to a variety of substrates in a number of convenient ways, including being sprayed on, being brushed or rolled on, or by dipping the product in the sealant.

The solvent blend can vary depending upon the particular end application. One acceptable blend is a mixture of volatile organic solvents. For example, in one preferred embodiment, the present invention is created by adding a micro crystalline wax to a chemical pre-mixture containing cyclohexane (CAS #110-82-7) and xylene (1330-20-7).

There are several distillates that can be used in substitution of the above mixture. For example, another preferred combination of the present invention is a solution comprising 60% cyclohexane, 5% isohexane, 5% hexane, 20% xylene, 7% ethylbenzene, 3% toluene. It should also be noted that rexene (CAS #64742-49-0) is a preferred alternate. The preferred solvent blends perform a critical task of keeping the micro-crystalline wax, which is normally a solid, in liquid form at ambient temperatures.

The preferred sealant composition is comprised of 5%-10% by volume micro crystalline wax (570-750 g/mole) in the solvent pre-mixture, based upon the total volume of sealant created.

A method is shown for formulating the sealant compositions of the invention in which a micro-crystalline wax is combined with a special pre-mixture which comprises an organic solvent blend. The sealant composition is prepared by adding the micro-crystalline wax to a solvent blend containing, for example, cyclohexane and xylene, the micro-crystalline wax being heated to its melting point and then added to the solvent blend at ambient temperature with frequent stirring until the micro-crystalline wax is completely dispersed throughout the solvent blend, thereby forming the liquid sealant barrier composition. The solvent blend is present in an amount effective to keep the normally solid micro-crystalline wax liquid at ambient temperatures. The sealant composition is then containerized and sealed. Upon application, the solvent blend is allowed to flash away after initial curing, leaving an essentially non-toxic and substantially solvent free micro-crystalline wax residue barrier on the subject substrate. The wax residue barrier blocks out air, water, UV rays, acids and moisture on a variety of surfaces and objects. Once cured, the formulations of the invention form a high performance protective barrier that is durable, weatherproof and resistant to rain, snow, wind, air, moisture, UV degradation, as well as to high ambient temperatures and natural weathering. Since the formulations air cure, there is no need for post application curing steps or external curing aids.

Among the advantageous attributes of the sealant composition of the invention are:

The ease of application;

Convenient cure time;

The hydrophobic nature of the of the resulting barrier;

The green, environmentally friendly nature of the product;

The product's essentially inert nature;

The cost saving involved in using the product.

Additional objects, features and advantages will be apparent from the written description which follows.

### DETAILED DESCRIPTION OF THE INVENTION

The invention described herein and the various features and advantageous details thereof are explained more fully with reference to the non-limiting examples which are detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

The sealant compositions of the invention are prepared by combining a hydrophobic component with a special organic solvent pre-mixture blend. The hydrophobic component is preferably a strong hydrophobe. Exemplary strong hydrophobes include waxes, such as petroleum waxes, natural waxes, synthetic waxes, or a combination of these. Exemplary petroleum waxes include slack wax or microcrystalline wax. Exemplary natural waxes include bees' wax or carnauba wax. Exemplary synthetic waxes include polyethylene wax or oxidized polyethylene wax. Preferred waxes have a melting point in the range from about 30-100° C., more preferably in the range from about 40 to 95° C. The most preferred wax is a microcrystalline wax having a melting point in the range from about 60° C. to about 87.78° C. Exemplary concentrations of the hydrophobic component are 2 to 30 weight %, more preferably about 5 to 15 weight %, most preferably about 10 weight %, based on the total weight of the stain/sealant formulation.

Microcrystalline waxes are a type of wax that can be produced, for example, by de-oiling petrolatum, as part of the petroleum refining process. In contrast to the more familiar paraffin wax which contains mostly unbranched alkanes, microcrystalline wax contains a higher percentage of isoparaffinic (branched) hydrocarbons and naphthenic hydrocarbons. It is characterized by the fineness of its crystals in contrast to the larger crystal of paraffin wax. It consists ofhigh molecular weight saturated aliphatic hydrocarbons. It is generally darker, more viscous, denser, tackier and more elastic than paraffin waxes, and has a higher molecular weight and melting point. However, the microcrystalline wax can be further processed to achieve greater purity levels at the refinery level. The elastic and adhesive characteristics of microcrystalline waxes are related to the non-straight chain components which they contain. Typical microcrystalline wax crystal structure is small and thin, making them more flexible than paraffin wax. They are commonly used in cosmetic formulations, as well as a food ingredient.

Microcrystalline waxes when produced by wax refiners are typically produced to meet a number of ASTM specifications. These include congeal point (ASTM D938), needle penetration (D1321), color (ASTM D6045), and viscosity (ASTM D445). Microcrystalline waxes can generally be put into two categories: “laminating” grades and “hardening” grades. The laminating grades typically have a melt point of 140-175° F. (60-80° C.) and needle penetration of 25 or above. The hardening grades will range from about 175-200° F. (80-93° C.), and have a needle penetration of 25 or below. Color in both grades can range from brown to white, depending on the degree of processing done at the refinery level.

One preferred micro-crystalline wax suitable for purposes of the present invention has the following measured characteristics:

Melting point: 60-95° C.

Initial boiling point: >572° C.

Flash point: >200° C.

Evaporation Rate: <0.01 (Butyl acetate=1)

Vapor Pressure: <0.01 mm Hg (25° C.)

Vapor density: >5 (air=1)

Relative density: 0.91 to 0.94 (25° C.)

Solubility: <0.1% (20° C.)

Partition coefficient (oil/water): <0.01

The liquid sealant barrier of the invention can be used to protect various subject substrates from water, salt, and any other corrosive or damaging influences in the surrounding environment. The present invention may conveniently be applied as a spray, for example by using high pressure airless sprayers, low pressure pump sprayers, hand sprayer bottles and aerosol canisters. Other applications techniques such as brushing on, rolling on and dipping a subject article into a container of the liquid sealant barrier are also possible, depending upon the particular end application.

In one aspect of the invention, a method is described for treating a substrate with a sealant composition comprising the steps of:

formulating a sealant composition by combining a micro-crystalline wax with an organic solvent pre-mixture blend;

contacting the substrate with the sealant composition and allowing the solvent blend to flash away, leaving a substantially solvent free micro-crystalline wax residue barrier.

By way of example, in one preferred embodiment, the sealant composition of the invention is prepared by adding a micro crystalline wax (wax) to a chemical pre-mixture containing cyclohexane (CAS #110-82-7) and xylene (1330-20-7). The wax is heated to the melting point and then added to the pre-mixture at ambient temperature stirring frequently and consistently until the wax has been completely disbursed throughout the chemical pre-mix. The visual results are a milky white to amber brown liquid, depending on the type of wax used.

There are several distillates that can be used in substitution of the above mixture. For example, one preferred combination of the present invention is a solution comprising 60% cyclohexane, 5% isohexane, 5% hexane, 20% xylene, 7% ethylbenzene, 3% toluene. It should also be noted that rexene (CAS #64742-49-0) is a preferred alternate.

The preferred embodiment is comprised of 5%-10% by volume micro crystalline wax (570-750 g/mole), based upon the total volume of solvent blend.

The exact nature of the solvent blend may vary to some extent, depending upon the end application. In every case, the particular combination of solvents with micro crystalline wax allows the wax to remain liquid at temperatures below the cooling point of the wax. The combination of distillates used in the solvent blend will always have a lighter specific gravity than that of the microcrystalline wax component. Of the solvents used in the solvent blend, the most notable is xylene. Xylene's primary function is to prepare the exposed surface of an object to be sealed.

The other solvents in the exemplary blends basically work together as “filler” to create “volume” in the solution to allow for a wide and thinly dispersed application. The solvents also are more cost effective and make the product more affordable, allowing for more uses in applications generally served by oil based products.

The combination of distillates having a lighter specific gravity than that of the wax performs the function of keeping the wax from re-solidifying into a solid piece, as well as keeping the wax in a liquid form which can be applied in a variety of methods including but not limited to brushing, rolling and spraying. In other words, the preferred solvent blends perform a critical task of keeping the micro-crystalline wax, which is normally a solid, in liquid form at ambient temperatures. This function is vital in order to use and apply the present invention “in the field” on a variety of different products that could be harmed by the elements.

The wax used in the mixture of the present invention can vary in molecular weight, however the use of a wax with a high tensile strength is recommended for its ability to adhere without losing its bonding affinity to the item being sealed.

An invention has been provided with several advantages. There are many thousands of potential uses of the present invention, both commercial and industrial. To name a few, the sealant composition of the invention can be applied to:

Fresh and salt water marine vessels above and below the water displacement line

Fishing equipment

Exposed Electronic Connections

Metal Components, Propellers, Outdrives

Firearms: Metal and Wood Surfaces

Printed Circuit Boards

Industrial: Metal and Steel components for the oil and gas industry

Communication Antennas

Outdoor garden and pool copings, retaining walls, fire places, railing fences (wood and metal)

Rail and transit, multiple static surfaces

Vehicles: battery terminals, trailer light plugs, wheel wells, fuse boxes, wheels and tires.

Construction: faux tile roofs, wood, cement and rock decks, wood and metal fences; multiple surfaces from rough-in stage to completion of trim stages in any project

Municipalities in graffiti abatement programs

General: clothing, camping equipment, hats, leather shoes, gloves, flashlights, exposed wood, power tools, hand tools.

The sealant composition of the invention can be used with any product where exposure to moisture, salt, or other environmental influences may be harmful to the functioning of the product. The sealant composition can be applied as a spray in a liquid form, making it easy to apply to any of the aforementioned products.

In order to illustrate the effectiveness of the protective coating compositions of the invention, two different marine vessels, both dual outboard engines, approximately 30-50 feet length were coated up to the approximate water displacement line with the coating composition of the invention. One vessel was left docked for a year. The other vessel was used on a normal daily basis. Coating each vessel took less than 40 minutes using a hand sprayer.

The docked vessel was pulled from the salt water after approximately one year and was covered in barnacles and marine fouling up to the water displacement line. A high pressure sprayer using simple water was used to remove the barnacles in less than two hours. This type of removal usually requires chiseling, grinding wheels and even other toxic dissolving chemicals. Generally, the process follows:

One day to remove the barnacles;

One day to prime coat and cure; and

A third day to apply Epaint™ or a similar coating and cure.

The entire process is expensive, time consuming and takes the vessel out of service during the maintenance period. Applicant's process is economical, time saving and eliminates the need for recoating. The vessel can be put directly back into service.

The results on the vessel which was in daily use were even more surprising. After a year of use, the vessel was essentially clean. It appears that contaminants do not adhere to the coated surfaces of the vessel long enough to overcome the drag of the water while in use. They are literally sheared off.

While the invention has been shown in several of its forms, it is not thus limited but is susceptible to various changes and modifications without departing from the spirit thereof, as described in the claims which follow.

What is claimed is:

1. A method for treating a substrate with a sealant composition comprising the steps of:
formulating a sealant composition by combining a micro-crystalline wax with an organic solvent pre-mixture blend;
contacting the substrate with the sealant composition and allowing the solvent blend to flash away, leaving a substantially solvent free micro-crystalline wax residue barrier; and
wherein the solvent blend chosen is effective to keep the micro-crystalline wax emulsified in a liquid state at ambient temperatures prior to application.

2. The method of claim 1, wherein the sealant composition is sprayed onto the substrate.

3. The method of claim 1, wherein the organic solvent pre-mixture blend is a blend of xylene with other distillates which work together as a filler to create volume in the sealant composition.

4. The method of claim 3, wherein the combination of distillates has a lighter specific gravity than that of the microcrystalline wax so that the solvent blend keeps the wax from re-solidifying into a solid piece.

5. The method of claim 1, wherein the organic solvent blend is a blend of at least cyclohexane and xylene.

6. The method of claim 1, wherein the organic solvent blend is a solution of approximately 60% cyclohexane, 5% isohexane, 20% xylene, 7% ethylbenzene and 3% toluene, all percents being percents by volume, based upon the total volume of the sealant composition.

7. The method of claim 1, wherein the sealant composition is comprised of 5 to 10% by volume micro-crystalline wax, based upon the total volume of the sealant composition.

8. The method of claim 1, wherein the preferred micro-crystalline wax has a weight of about 570-750 g/mole.

9. A method for treating a substrate with a sealant composition, comprising the steps of:
formulating a sealant composition which is comprised of a micro-crystalline wax in an organic solvent pre-mixture blend;
wherein the sealant composition is prepared by adding the micro-crystalline wax to the solvent pre-mixture blend containing at least cyclohexane and xylene, the micro-crystalline wax being heated to its melting point and then added to the solvent pre-mixture blend at ambient temperature with frequent stirring until the micro-crystalline wax is completely dispersed throughout the solvent blend, thereby forming the sealant composition;
wherein the solvent blend chosen is effective to keep the micro-crystalline wax emulsified in a liquid state at ambient temperatures prior to application; and
thereafter, contacting the substrate with the sealant composition and allowing the solvent blend to flash away after initial curing, leaving a non-toxic and substantially solvent free micro-crystalline wax residue barrier.

10. The method of claim 9, wherein the sealant composition is sprayed onto the wood substrate.

11. The method of claim 9, wherein the sealant composition is brushed onto the wood substrate.

12. The method of claim 9, wherein the sealant composition is rolled on.

13. The method of claim 9, wherein the organic solvent pre-mixture blend is a blend of at least cyclohexane and xylene.

14. The method of claim 9, wherein the organic solvent pre-mixture blend is a solution of approximately 60% cyclohexane, 5% isohexane, 20% xylene, 7% ethylbenzene and 3% toluene, all percents being percents by volume, based upon the total volume of the sealant composition.

15. The method of claim 9, wherein the sealant composition is comprised of 5 to 10% by volume micro-crystalline wax, based upon the total volume of the sealant composition.

16. The method of claim 9, wherein the preferred micro-crystalline wax has a weight of about 570-750 g/mole.

17. A sealant composition for a variety of different substrates, the composition comprising:
an initially liquid composition which is formulated by combining a micro-crystalline wax with an organic solvent pre-mixture blend;
wherein the solvent blend chosen is effective to keep the micro-crystalline wax emulsified in a liquid state at ambient temperatures prior to application; and wherein the initially liquid composition is subsequently applied to the substrate with the solvent pre-mixture blend subsequently being allowed to flash away, leaving a substantially solvent free micro-crystalline wax residue barrier on the substrate.

18. The composition of claim 17, wherein the organic solvent blend is a blend of at least cyclohexane and xylene.

19. The composition of claim 17, wherein the organic solvent pre-mixture blend is a solution of approximately 60% cyclohexane, 5% isohexane, 20% xylene, 7% ethylbenzene and 3% toluene, all percents being percents by volume, based upon the total volume of the sealant composition.

20. The composition of claim 17, wherein the sealant composition is comprised of 5 to 10% by volume micro-crystalline wax, based upon the total volume of the sealant composition.

21. The composition of claim 17, wherein the preferred micro-crystalline wax has a weight of about 570-750 g/mole.
